(19) United States
(12) Patent Application Publication
(10) Pub. No.: US 2019/0122302 A1
(43) Pub. Date: Apr. 25, 2019

(54) METHOD AND SYSTEM OF AUTOMATIC TARGET DATE DISTRIBUTION OF RETIREMENT FUNDS

(71) Applicant: Huazhou Lou, Eden Prairie, MN (US)

(72) Inventor: Huazhou Lou, Eden Prairie, MN (US)

(21) Appl. No.: 15/791,318

(22) Filed: Oct. 23, 2017

(51) Int. Cl. G06Q 40/06; G06Q 20/10

(52) U.S. Cl. CPC G06Q 40/06; G06Q 40/04; G06Q 20/10

(57) ABSTRACT

A method of making periodic retirement fund distributions executed automatically by a computer system comprises a predetermined start date, target end date and frequency of distribution that will provide the investor the exact time duration that the retirement funds will last. The method includes creating a periodic distribution schedule, calculating distribution percentage rate for each distribution, determining the shares to be sold at each distribution while maintaining the remaining funds fully invested. The total distribution time duration is predetermined and fixed. The distribution percentage rate is calculated to create a purchasing power equalized distribution amount in the entire distribution duration by factoring net investment return rate after inflation. The method also includes a cash buffering mechanism to smooth out market fluctuations while providing investment growth.

### BACKGROUND OF THE INVENTION

Many working people have accumulated the necessary retirement funds through work place defined contribution retirement or individual retirement account (IRA) during their working years. Most will rely on their retirement funds to cover living expenses during retirement years. However, many people are not financially savvy or are not interested in managing their retirement funds investment and distribution. Yet they are handed a large sum of their lifetime accumulation upon retirement that they must manage to provide their living expenses for the rest of their life.

There are a few options of prior art in retirement fund distribution. People can spend as they wish, but the risk is their retirement funds may quickly deplete way ahead of their life expectancy. They can live extremely frugal without spending down the funds, but their life quality will suffer. They can purchase annuity insurances or hire a financial advisor, but this will incur substantial costs on the retirement funds. Another option is using the 4% rule of thumb, which is to withdraw 4% of funds at the first year of retirement and adjust the distribution amount by inflation for the remaining years of life. The risk of the 4% rule is the number of years that the funds can last will vary greatly depending on investment returns and inflation.

During retirement funds accumulation in their working years, people can enroll in defined contribution plans, such as 401k, 403b, or individual retirement account to automatically save certain percentage of the income from every pay check into target date retirement funds. This retirement assets accumulation process is automatic, periodic and passive. Participants of the retirement plan do not need any financial skills and active management to accumulate retirement funds. There should also be ways to distribute retirement funds without the need of financial skills and active management.

### SUMMARY OF THE INVENTION

The present invention disclosure provides a computerized automatic, passive and low cost method to convert and distribute retirement funds into periodically scheduled living expenses for a predictable number of years.

A method of the present disclosure comprises a sum of retirement funds accumulated during the investor's working life. The retirement funds comprise a singular or plural investment funds depending on investor's choices, such as but not limited to, index funds or target date funds. The retirement funds will continue to be invested during the entire time the periodic distributions are made to the investor.

A method of making distributions from retirement funds of the present disclosure comprises determining target number of years that the funds will be distributed, the expected net rate of return of the investment. The net rate of return of the investment is the market return rate minus inflation rate. The investor will determine the total target number of years for the distribution to last. A computer program, using inputs of total target number of years and estimated net investment return rate, calculates a percentage distribution rate for each year of the distribution and creates a table of distribution schedule for the total target number of years.

A method of making distributions from retirement funds of the present disclosure comprises a computer program calculating the total number of shares of each retirement fund in the retirement fund portfolio at the time of a periodic distribution is made, determining how many more years the funds are targeted to last, calculating the percentage distribution rate for the current year, determining the number of distributions per year, dividing the percentage distribution rate for the current year by the number of distributions per year. This is the percent distribution rate for the current distribution period. The computer program multiplies the number of shares of each fund in the retirement fund portfolio by the percent distribution rate for the current distribution period. The product of the multiplication is the number of shares of each fund in the retirement fund portfolio allocated to be sold for the current distribution period. The computer program will sell the allocated shares and distribute the proceeds to the investor.

A method of determining percentage distribution rate for each year throughout the target number of years of distribution comprises estimated net investment rate of return which is the difference between the market return rate and inflation rate. The percentage distribution rate of the method in the present invention disclosure is designed to deliver inflation adjusted purchasing power equalized distributions for the entire distribution length. The purchasing power of distributions is flat in long term with fluctuations in short term.

A method of making distributions from retirement funds comprises a computerized automatic mechanism of dollar amount distribution adjusted for retirement funds market performance. At each periodic distribution date, the computer program will calculate and allocate the shares to be sold and automatically sell the shares disregarding market conditions. This eliminates the human influence of market timing. More dollar amount will be distributed when the market has gone up and less dollar amount will be distributed when the market has gone down. The mechanism of distributing more dollar amount in up market and less dollar amount in down market will reduce market risks in an up market and preserve funds for future growth in a down market.

A method making distributions from retirement funds comprises computerized automatic processes that will distribute funds periodically for a predetermined number of years at a predetermined frequency per year. An investor can let this distribution process run automatically and receive periodic distributions just like receiving regular pay checks.

A method of building a cash buffer to smooth out market fluctuations comprises holding off the payments of the first L number of periodic distributions and deposit them in a cash buffer. L is the cash buffer length in the unit of number of distributions. The investor will not receive payments for the first L number of periodic distributions. There is a delay of L number of distributions between the start of selling of the retirement funds and the first cash payment to the investor for accumulating the cash buffer. Starting at (L+1)th distribution, at each periodic distribution, The cash payment dollar amount of the current periodic distribution is calculated to be the total cash buffer value divided by L. After the cash payment, the allocated shares of retirement funds for the current distribution are sold and the proceeds will be added to the cash buffer. This moving averaging process will smooth out market fluctuation effect on payment fluctuation. For the last L distributions, all the retirement funds have been sold and all assets are in the cash buffer. The cash payment amount of the last L number of distributions is the cash buffer value divided by the remaining number of distribution payments. The entire process of accumulating the cash buffer, smoothing out market fluctuations, depleting the cash buffer after all funds have been sold is executed by a computer program with a cash buffer length input from the investor.

### BRIEF DESCRIPTION OF THE DRAWINGS

FIG. 1 is a flowchart of retirement funds accumulation and distribution life cycle according to an example embodiment.

FIG. 2 is a histogram of the number of years the retirement funds will last with 4% rule from a Monte Carlo simulation.

FIG. 3 is a histogram of the number of years the retirement funds will last with the method of the present invention disclosure, target date distribution method, from a Monte Carlo simulation.

FIG. 4 is a flowchart of calculating the purchasing power equalized distribution rate for each year for a total of N years.

FIGS. 5A-5B are tables of annual distribution percentage rate. 5A is for 1 to 50 years to target. 5B is for 51 to 100 years to target.

FIG. 6 is a flowchart of calculation of share number and dollar amount distribution of each periodic distribution.

FIG. 7 is a flowchart illustrating share price averaging distribution method according to an example embodiment.

FIG. 8 is a flowchart illustrating share price averaging distribution method of multiple funds according to an example embodiment.

FIG. 9 is a block diagram of a system of multiple fund groups with different distribution plans according to an example embodiment

FIG. 10 is a flowchart illustrating a distribution method with a cash buffer

### DETAILED DESCRIPTION OF THE INVENTION

The present disclosure generally relates to the methods of distributing retirement funds to investors. For people participating in defined contribution retirement plans through employment or through IRAs, money from each pay period are automatically deducted from pay checks and deposited to retirement plan accounts. The money contributed to retirement accounts are automatically invested in a number of investment funds selected by the investor. The process of accumulating retirement funds can be set automatic and the investor does not need any special skills to manage the retirement accounts. This automatic dollar cost averaging periodic investment method has the advantage of smoothing out investment market fluctuations and low cost of managing.

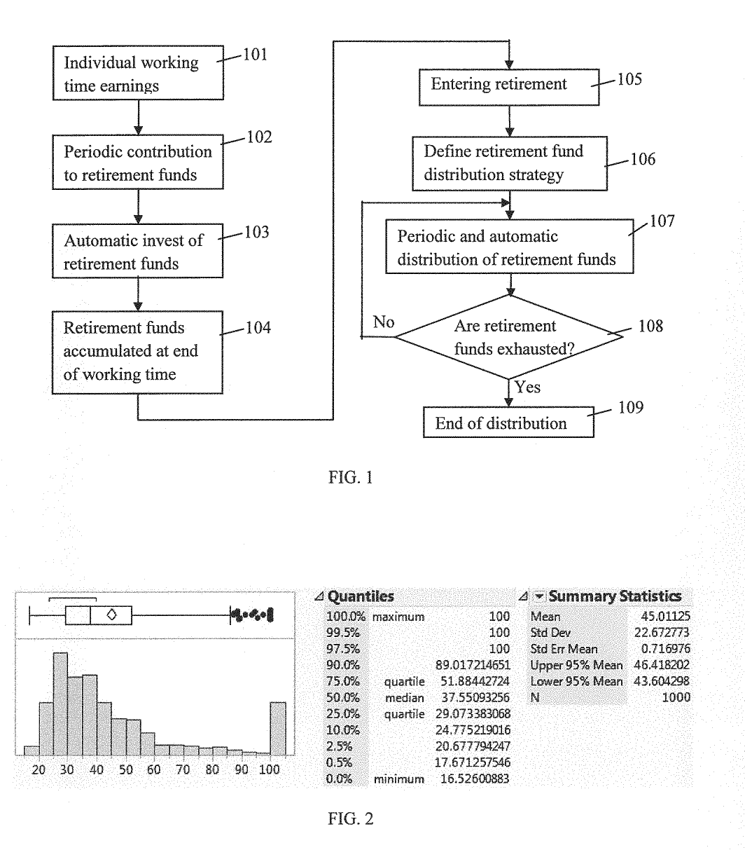

In reference to FIG. 1, a block diagram shows the life cycle of an investor's retirement funds accumulation during working time and distribution during retirement. For an individual who is enrolled in a defined contribution retirement plan, such as 401k, 403b or IRA, a part of the individual's income 101 is contributed to a retirement portfolio of funds 102. This retirement fund contribution occurs periodically at each pay period and is automatically invested in a variety of funds 103 that the individual has chosen, such as mutual funds, index funds, target date funds. The retirement funds 104 are accumulated during the entire working time of the individual. When the individual enters retirement 105, the process will be reversed from retirement fund accumulation to retirement fund distribution. With a large sum of retirement funds at hand to support the individual's retirement expenses for the rest of the life, the individual will determine a retirement fund distribution strategy 106. The retirement fund distribution strategy will periodically and automatically distribute certain amount of funds for the individual's retirement expenses 107. The distribution process will repeat periodically and the remaining of the funds are checked 108. When all the retirement funds are exhausted, the distribution process ends. One major risk of retirement funds distribution is that the retiree or his/her dependents may out live the retirement funds.

A prior art rule of thumb of retirement fund distribution method is the 4% rule which is distributing 4% of the retirement funds at the first year of retirement, adjusting the distribution dollar amount with inflation in subsequent years until the funds run out. The 4% rule of distribution will result very large variations in the number of years the retirement funds will last depending on investment returns and inflation. FIG. 2 is a histogram of a Monte Carlo simulation of the total number of years the retirement funds will last with 4% rule. The simulation assumes 6% mean investment return rate with 9% standard deviation, and 3% mean inflation rate with 1.2% standard deviation. There is a 50% percent chance that the retirement funds will last 37.5 years. There is a 10% chance that the retirement funds will only last 24 years. This uncertainty of how long the retirement funds will last poses a threat to a financially secure retirement.

The distribution method of the present invention disclosure is designed to have a fixed number of years of distribution disregarding inflation rate and market conditions. An investor at the time of retirement can select a retirement funds distribution schedule to last to a target date.

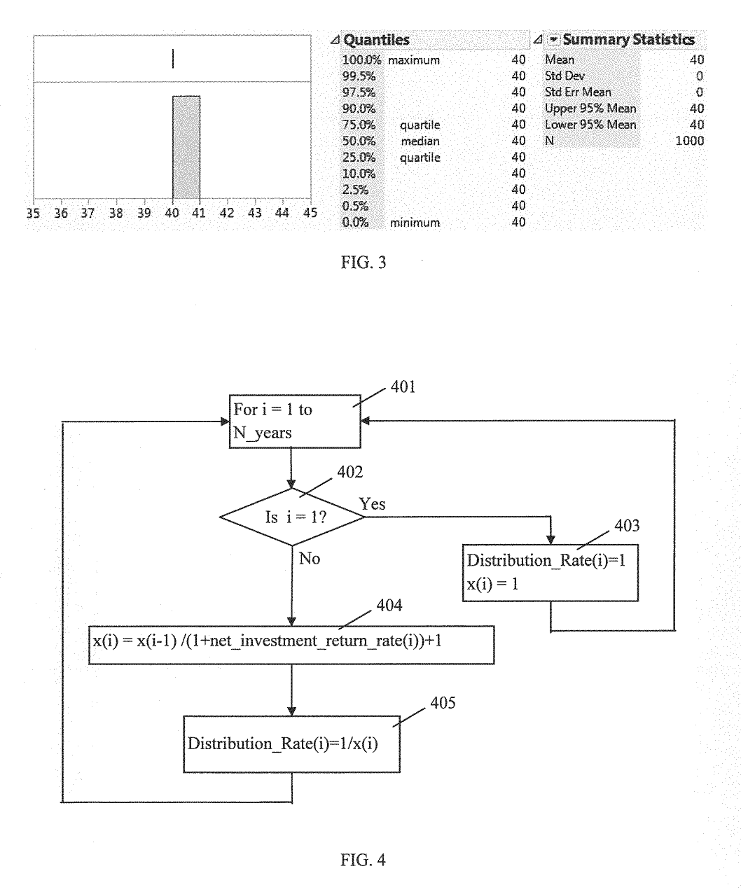

The target date retirement funds distribution method of the present disclosure will provide the certainty of how long the retirement funds will last. FIG. 3 is a histogram of a Monte Carlo simulation of the total number of years the retirement funds will last with the method of the present invention disclosure under the same market conditions as the 4% rule simulation in FIG. 2. As shown in FIG. 3, the target date distribution method of the present invention disclosure will always last for 40 years because it is designed to last for 40 years. Even though FIG. 3 shows an example of a 40 years distribution, the method of the present invention disclosure can design a retirement funds distribution schedule for any number of years.

The target date distribution method of the present invention disclosure factors in the expected net rate of investment return to equalize the purchasing power of the distribution throughout the entire duration of distribution. Net rate of investment return is the market return rate minus the inflation rate. Equalized purchasing power means the purchasing power of the distributions to the investor will stay flat in the long term if the actual net investment rate matches the expected net investment rate.

When an investor enrolls in a target date retirement fund distribution plan, the investor will select the start year, end year of distributions, number of distributions per year, and the expected net investment return rate. A computer program is written to receive the investor inputs of start year, end year, number of distributions per year and expected net investment return rate. The computer program calculates the distribution rate for the entire plan schedule based on the method in FIG. 4. FIG. 4 is a flowchart of calculating the purchasing power equalized distribution rate for each year for a total of N years. It uses a variable Year_To_Target which is the number of years the remaining retirement funds should last. The computer program calculates the distribution rate in a reverse order starting from the last year of distribution when Year_To_Target=1 and distribution rate is 100%. It then iteratively calculates the rate of distribution for each year earlier by incrementing Year_To_Target. The expected net rate of investment return will be factored in the calculation to produce equalized purchasing power for the distributions. The net rate of investment return equals to market return minus inflation rate. For example, if market return rate is 6% and inflation is 3%, the net rate of investment return is 3%.

In reference to FIG. 4, step 401 defines the number of iterations, which is the number of years in one embodiment, of distribution rate calculation. Variable i is the Year_To_Target in each iteration of calculation. Variable i increments from 1 to the total number of years N_years. Step 402 checks if Year_To_Target is 1 which is the last year of distribution but is calculated in the first iteration in the reverse order calculations. Step 403 is the case of the last year of distribution in which distribution rate should be 1 or 100%. 403, which is for the last year of distribution, also defines the starting value of the intermediate variable of the iterative calculation x(i)=1. Step 404 calculates the intermediate variable of iterative calculations x(i) based on previous Year_To_Target x(i−1), which is in fact the next distribution year because it's in a reverse order, and the net investment return rate. Step 405 calculates the distribution rate for each year. The iterative reverse order calculation process of the retirement funds distribution rate of the present invention disclosure shown in FIG. 4 is performed by a computer program. The net investment return rate in the iterative calculation of distribution rate can be a constant, or can vary with the number of years to target depending on investment choices. The distribution rate for a year divided by the number of distributions per year is the distribution rate for a scheduled distribution. Although the embodiment of the distribution rate calculation uses year as a time unit, it should be understood the time unit is not limited to year and the calculation of distribution rate can use any time unit.

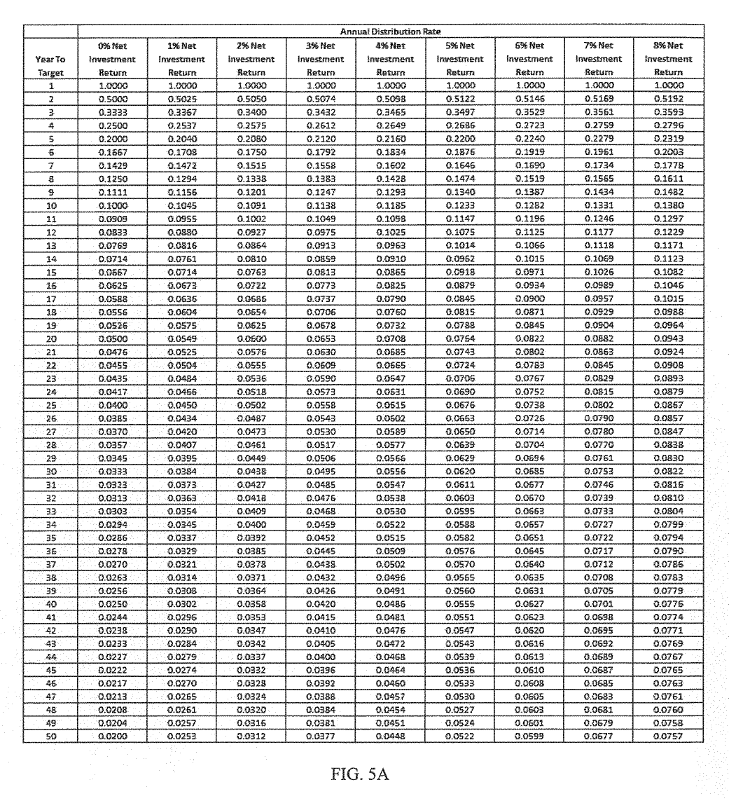

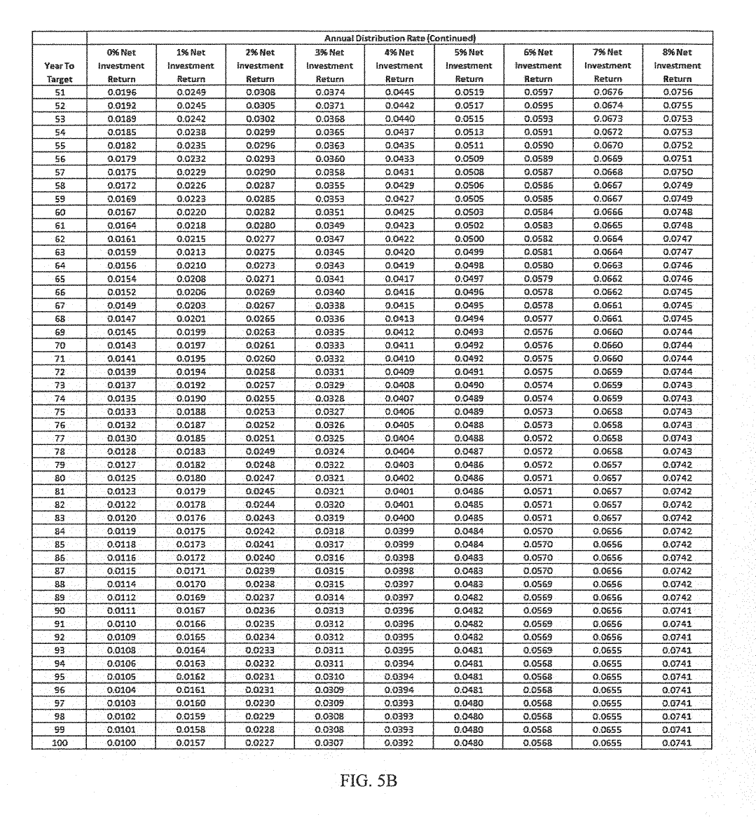

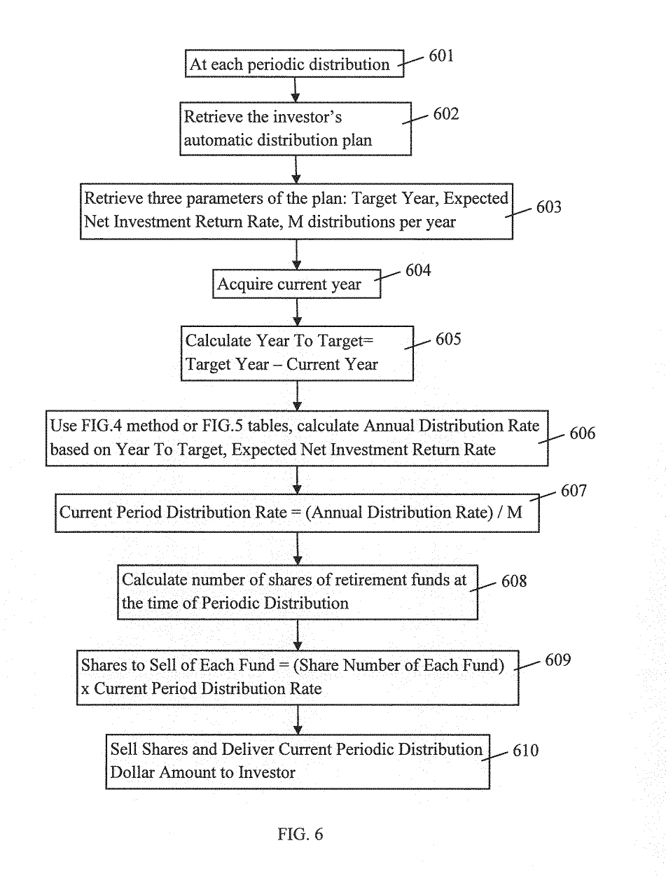

FIG. 5A and FIG. 5B are a table of annual distribution rate for 100 years for 9 levels of net investment return rate. The distribution rates in FIG. 5A and FIG. 5B are calculated by a computer program using the method described in FIG. 4. Net investment return rate is the market investment return rate subtracted by inflation rate. Although FIG. 5A and FIG. 5B show an exemplary results of distribution rate for a limited number of cases, distribution rate for any number of years and any net investment return rate can be calculated using the method described in FIG. 4.

A retirement plan administrator or service provider can use the annual distribution rate calculation method described in FIG. 4 or the annual distribution rate tables in FIGS. 5A and 5B, which are calculated using the method described in FIG. 4, to provide automatic retirement funds distribution services to investors. When an investor enrolls in a retirement fund distribution plan, the investor will determine a start year and a target end year that he or she wishes the funds will be completely distributed. The target year of the end of distribution should be longer than the longest expectation of the life expectancy of the investor and the dependants of the investor whom the retirement funds will support. The investor will also determine an expected net investment return rate of return based on the retirement funds portfolio and the number of distributions per year. After the target year of the distribution and the expected net investment return rate are determined, the retirement plan administrator, by using a computer system, will create an automatic distribution plan which will periodically distribute long term purchasing power equalized funds to the investor. The automatic distribution plan has three predetermined parameters. They are Target Tear, Expected Net Investment Return Rate and M periodic distributions per year.

The M times per year of periodic distribution can be quarterly, monthly, weekly or any periodicity. At each periodic distribution, the retirement plan computer system will use the steps described in FIG. 6 to determine the dollar amount of distribution for the investor.

Referring to FIG. 6, at each periodic distribution 601, the retirement fund plan computer system will retrieve the investor's automatic retirement fund distribution plan 602. The retirement fund plan computer system retrieves target year, expected net investment return rate, the number of repeated distributions per year, M, 603. The target year is the year in the future that the retirement funds is designed to be completely drawn down to zero. Net investment return rate is the market investment return rate minus inflation rate. The investor determines the target year, net investment return rate and the number of distributions per year, M, when enrolling in the automatic retirement fund distribution plan. The retirement fund plan computer system acquires the current year 604, calculates year to target 605, which is the number of years the funds should last from the current date. The current year annual distribution rate is calculated in step 606 using the method described in FIG. 4 or using tables in FIGS. 5A and 5B. The distribution rate of the current period distribution rate is the annual distribution rate divided by M, in step 607. The retirement fund plan computer system then calculates the number of shares of each fund in the retirement fund, step 608. The number of shares allocated to sell for each fund equals the total number of shares of each fund multiplied by the current period distribution rate, step 609. The calculation of the number of shares to sell for each fund is repeated for each fund in the retirement fund portfolio. The allocated shares of funds are sold and cash proceeds of the sale of are delivered to the investor in step 610. The periodic distribution process of the present invention disclosure described in FIG. 6 will be performed by a computer program automatically in the same fashion as a payroll payment. The investor will receive the periodic cash distribution in the same fashion as receiving periodic pay checks. The remaining of the retirement funds will continue to be invested.

The method of automatic distribution of retirement funds of the present invention disclosure is designed to have a flat inflation adjusted distribution amount, or equalized purchasing power, for the entire distribution duration. The equalized purchasing power distribution only holds when the average actual net investment return rate matches the expected net investment return rate for the distribution plan input. When the average long term actual net investment return rate deviates from the expected net investment return rate input to the distribution plan, distributions will still last to the target year but the inflation adjusted distributions will increase or decrease over time in long term. The expected net return rate input to the distribution plan can be adjusted by the investor and the distribution rate recalculated if the actual net return rate averaged in many years has deviated from the expectation.

All three input parameters to the automatic purchasing power equalized distribution, the target year when all the funds are distributed, the expected net investment return rate and the number of distributions per year, can be adjusted during the life time of distribution. Investors can make adjustments based on long term shift in investment or life situations.

An embodiment of the target date retirement fund distribution method of the present invention disclosure is the purchasing power equalized retirement funds distribution method. The purchasing power equalized retirement funds distribution method is a share price averaging method of distribution. It sells a target percentage of the retirement fund shares on a regular schedule regardless of the market conditions. If the long term net investment return rate is assumed to be 0, the share price averaging method will sell equal number of shares at each periodic distribution. If the long term net investment return rate is assumed to be greater than 0, the number of shares to be sold at each periodic distribution will slide from more shares at the beginning to fewer shares at the end of distribution because the net investment return will produce equal purchasing power dollar amount at each distribution. The share price averaging method of distribution is a market exit strategy designed to have more money exit the market when prices are high to reduce the market risk and less money exit the market when prices are low to preserve funds for future growth. The share price averaging method avoids the devastating situation of pulling large sum of investments out of the market at the wrong time when prices are low during a panic sell off. It avoids market timing mistakes during the market exiting phase of the investment by periodically selling investments to smooth out market fluctuations.

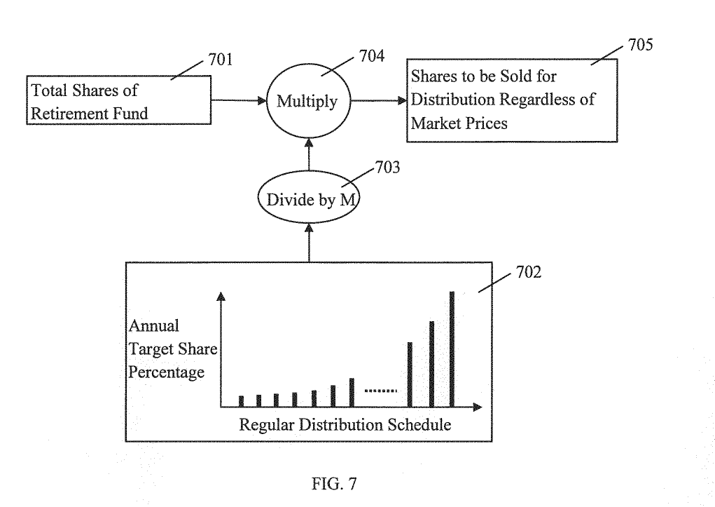

FIG. 7 describes the share price averaging distribution method. At each periodic distribution on a regular schedule, the annual target share percentage in 702 is calculated with the method described in FIG.4 or table in FIG. 5A and 5B. The annual target share percentage 702 is divided by M in step 703 where M is the number of distributions per year in the distribution plan. The output of 703 is the percentage of the shares to be sold for the current periodic distribution. The share number of retirement funds 701 is multiplied by the output of 703, the percentage of shares to sell. The product of the multiplication from 704 is the number of shares to sell for the retirement funds in 701 regardless of market prices. The proceeds from the sale of shares in 705 are the dollar amount to be distributed to the investor for the current periodic distribution.

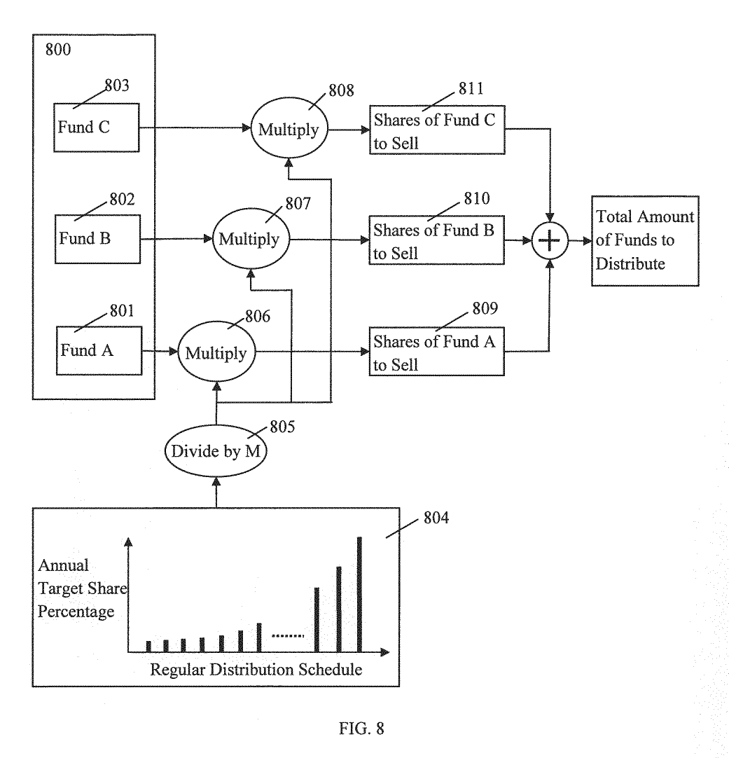

FIG. 8 is a variation when there are multiple funds in a retirement fund portfolio 800, fund A 801, fund B 802 and fund C 803. The number of funds in the investment fund portfolio can be unlimited. The share price averaging distribution method will be applied to each fund in the investment portfolio 801, 802, 803. At each periodic distribution on a regular schedule, the annual target share percentage in 804 is calculated with the method described in FIG.4 or table in FIGS. 5A and 5B. The annual target share percentage 804 is divided by M in 805 where M in 805 is the number of distributions per year in the distribution plan. The output of 805 is the percentage of the shares to be sold for the current periodic distribution. The shares of fund A 801, fund B 802 and fund C 803 are multiplied by the output of 805, the percentage of shares to sell, separately. The product of the multiplications from 806, 807 and 808 are the number of shares to sell for each fund in 800. Adding the sales proceeds of 809, 810 and 811 will be the total amount of funds to be distributed for the current distribution period.

Another variation of the present invention disclosure is that an investor has multiple accounts of investment portfolios, account A, account B, account C. Target date distribution method can be applied to each account of the investment portfolios that the investor owns.

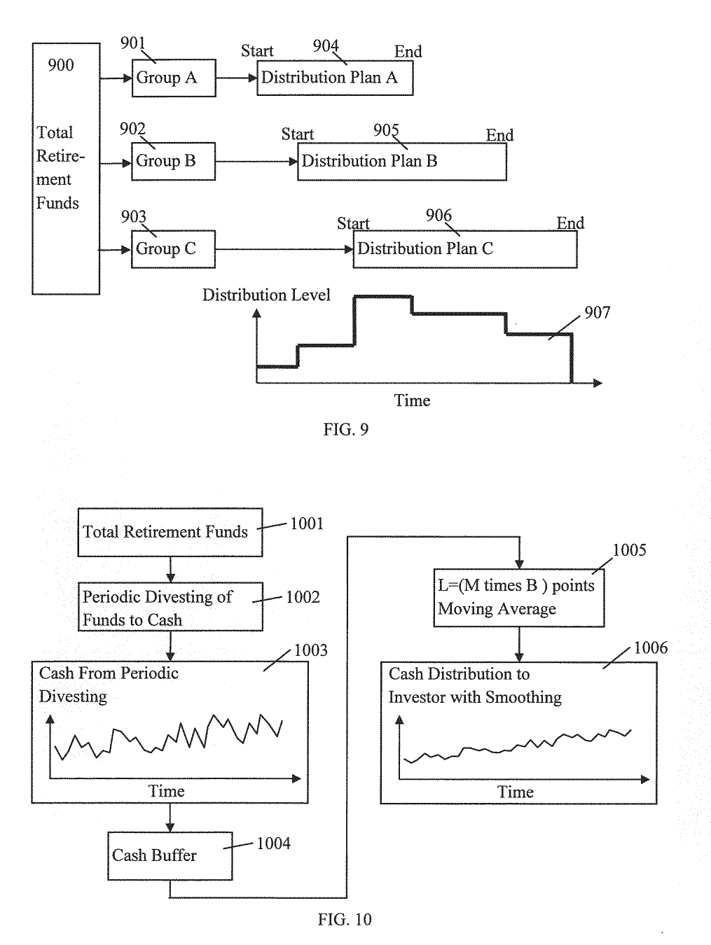

Some investors will have different sources of retirement income at different stages of retirement. An investor may need one level of retirement fund distribution for a number of years before stepping to a different level of retirement fund distribution once another source of income, such as social security or pension, starts or ends. To create different levels of retirement fund distribution at different stages of retirement, total retirement funds are separated into several groups, for example, fund group A, fund group B, fund group C. Each fund group is enrolled in a different distribution plan, for example, plan A, plan B, plan C. Each distribution plan can have different inputs of start date, end date, number of distributions per year and expected net investment return rate. Each fund group and its distribution plan are executed independently by a computer program. FIG. 9 illustrates separating total retirement funds into several groups with different distribution plans that have different start dates, end date, distributions per year and expected net investment return rate. Total retirement funds 900 are divided into group A 901, group B 902 and group C 903. Group A 901 is enrolled in distribution plan A 904. Group B 902 is enrolled in distribution plan B 905. Group C 903 is enrolled in distribution plan C 906. Distribution plan A 904, distribution plan B 905 and distribution plan C 906 can have different and independent start date, end date, distributions per year and expected net investment return rate. 907 is the distribution level versus time. An investor can allocate total retirement funds into different groups and enroll different groups of funds in different distribution plans to created different levels of distribution in different stages of life.

During the entire retirement fund distribution time, the retirement funds will stay invested in the market to provide growth. The market price of the retirement funds will fluctuate. The distributions to the investor will also fluctuate due to market fluctuation. To reduce the fluctuation in periodic distribution of retirement funds, the investor can choose to build a cash buffer to smooth out the fluctuation by creating a time difference between the periodic selling of retirement funds and the periodic cash payment. The details are described in the following.

The method of reducing the effect of market fluctuation on the periodic distribution of retirement funds in the present invention disclosure is to start periodic selling of investments ahead of periodic cash payment to the investor. Assume the investor enrolls in a distribution plan that distributes M times per year. The distribution plan can implement a buffering time of B years. The investor can choose B as one, two or any number of years even with a fraction number of years. Starting at B years before the investor plans to receive periodic cash payment of retirement funds, the retirement plan computer system will start to periodically sell the retirement investment funds at the same frequency and percentage as planned in the distribution plan. The proceeds from the sales will be saved in a cash buffer. The cash buffer can be in cash or cash equivalent vehicles such as money market funds, short term treasury bills, short term certificate of deposits, savings account. There will be a total of L=(M times B) number of periodic sales of retirement funds before the investor starts to receive retirement cash payments. L is the buffer length in the unit of the number of periodic distributions. Once the cash payment to the investor commences, at each periodic distribution date, the retirement plan computer system will first distribute cash to the investor. The amount of cash to be distributed to the investor for the current period equals to the cash buffer value divided by L, where L is the buffer length in the unit of number of distributions. After the cash payment is deducted from the cash buffer, the retirement plan computer system will sell the allocated shares of the retirement funds for the current distribution period and add the proceeds into the cash buffer. The amount of the retirement funds to sell for this distribution period is calculated with the method in FIG.6 steps 609 and 610 for the current distribution. This distribution process will repeat until target year minus B years. For the last B years of the distribution, there will be L number of distributions remaining and all the retirement funds have been sold and converted to cash buffer. The cash payment amount at each periodic distribution for the remaining distributions equals to the cash buffer value divided by the remaining number of distributions. The entire process of accumulating cash buffer, determining allocated shares to sell, selling the shares and distributing cash payments is executed by a computer program with a cash buffer length input from the investor. At each periodic distribution, the retirement plan computer system will also calculate the estimated cash payment for the next distribution to provide the investor the predictability for the next payment. The estimated cash payment for the next distribution is the cash buffer value divided by the buffer length.

A variation of the cash buffering method can be made by switching the order of cash distribution and the sale of funds for cash buffer at each periodic distribution even though this variation does not have significant effect on long term retirement fund distribution. At each periodic distribution date, the retirement plan computer system will first sell the retirement funds allocated for the current distribution period and add the proceeds into the cash buffer and then distribute cash payment to the investor. The amount of cash payment to be distributed to the investor for the current period equals to the cash buffer value divided by (L+1), where L is the buffer length in the unit of number distributions.

In reference to FIG. 10, the flowchart shows the cash buffer scheme to reduce the fluctuation in cash distributions to the investor at each scheduled distribution period. The investor has total retirement funds 1001 administrated by the retirement plan administration company. The retirement plan administration computer system periodically divests (sells) the funds for cash, step 1002, based on the automatic distribution plan that the investor has enrolled in. The cash proceeds from each periodic divesting 1003 will increase gradually over long term due to market growth, but it will fluctuate in short term due to market fluctuation. The cash generated from divesting of the retirement funds is not immediately distributed to the investor. Instead, the cash will be accumulated in a cash buffer 1004 for B years according to the investor's selection before being distributed to the investor. Once the cash buffer has accumulated for B years, periodic cash distribution will commence and each cash distribution amount will be calculated with a moving average, step 1005, of L=(M times B) data points of the prior L occurrences of the periodic divesting of funds. M is the number of distributions per year. B is the buffer length in years. B can be a fraction of a year. L is the buffer length in the unit of the number of periodic distributions. The periodic cash distribution out of the cash buffer to the investor, step 1006, will have much smaller fluctuations comparing to the periodic divesting of funds in step 1003. The cash buffer acts as a low path filter or reservoir to smooth out the market fluctuations. For the last L distributions, all funds have been divested to cash and the cash distribution amount for each periodic distribution equals to the cash buffer value divided by the remaining number of distributions.

A variation of cash buffering without the B years of time for accumulating the cash buffer is to sale some shares of the retirement funds at the beginning of the distribution in addition to the regular scheduled distribution. The proceeds of the additional share sale are used as the cash buffer. The amount to sale equals to the desired buffer length times the amount of the first regular distribution. The buffer length is in the unit of the number of the scheduled distributions.

When an investor changes a retirement fund distribution plan that has a cash buffer, the investor can roll over the cash buffer into the new distribution plan and assign a cash buffer length to the cash buffer in the new plan.

Methods and systems disclosed herein may be implemented by a computer system. The investor will provide inputs such as start date, end date, number of distributions per year, expected net investment return rate to the computer program when enrolling in the retirement fund distribution plan. The computer program will create a periodic distribution schedule and calculate the distribution percentage rate for each distribution. At each distribution date, the computer program will automatically allocate the shares to be sold according to the distribution plan, distribution percentage rate and available retirement funds shares. The computer program will automatically sell the allocated shares for the current distribution and deliver cash payment to the investor. The complete process of each periodic distribution is executed by the computer program automatically.

Although the various embodiments described above use year as a time unit for calculating distribution percentage and amount, it should be understood that the present invention disclosure can use any unit for time.

Although the methods and systems disclosed in the present invention disclosure are used to distribute retirement funds, it should be understood that the present invention disclosure may used for any investment fund distribution for any purposes.

Methods and systems disclosed herein may include one or more of the features, methods, or combination thereof described herein. For example, a method may be implemented to include one or more of the features and/or processes above. It is intended that such system or method need not include all of the features and/or processes described herein, but may be implemented to include selected features and/or processes that provide useful functionality.

The various embodiments described above may be implemented using software modules that interact to provide particular results. One of skill in the computing arts can readily implement such described functionality, either at a modular level or as a whole, using knowledge generally known in the art. For example, the flowcharts illustrated herein may be used to create computer-readable instructions/code for execution by a processor. Such instructions may be stored on a non-transitory computer-readable medium and transferred to the processor for execution as is known in the art.

Various modifications and additions can be made to the disclosed embodiments discussed above. Accordingly, the scope of the present disclosure should not be limited by the particular embodiments described above, but should be defined only by the claims set forth below and equivalents thereof.

### REFERENCES CITED

### U.S. PATENT DOCUMENTS

U.S. Pat. No. 5,987,606 November 1999 Cirasole et al.

U.S. Pat. No. 6,879,964 B2 April 2005 Sauter et al.

U.S. Pat. No. 7,089,201 B1 August 2006 Dellinger et al.

U.S. Pat. No. 7,337,138 B2 February 2008 Sauter et al.

U.S. Pat. No. 7,620,577 B2 November 2009 Arnott et al.

U.S. Pat. No. 7,720,749 B2 May 2010 Sauter et al.

U.S. Pat. No. 7,835,963 B1 November 2010 Borzych et al.

U.S. Pat. No. 7,908,196 B2 March 2011 Bevacqua

U.S. Pat. No. 7,925,573 B2 April 2011 Sauter et al.

U.S. Pat. No. 8,090,646 B2 January 2012 Sauter et al.

U.S. Pat. No. 8,095,398 B2 January 2012 Dellinger et al.

U.S. Pat. No. 8,160,948 B2 April 2012 Finfrock et al.

U.S. Pat. No. 8,180,695 B2 May 2012 Ameriks et al.

U.S. Pat. No. 8,185,464 B1 May 2012 Ameriks et al.

U.S. Pat. No. 8,204,767 B2 June 2012 Dellinger et al.

U.S. Pat. No. 8,255,308 B2 August 2012 Dial et al.

U.S. Pat. No. 8,285,648 B2 October 2012 Goodin

U.S. Pat. No. 8,352,349 B2 January 2013 Surz

U.S. Pat. No. 8,386,361 B1 February 2013 Dial et al.

U.S. Pat. No. 8,396,775 B1 March 2013 Mindlin

U.S. Pat. No. 8,417,623 B2 April 2013 Sauter et al.

U.S. Pat. No. 8,429,052 B2 April 2013 Herr et al.

U.S. Pat. No. 8,751,345 B1 June 2014 Borzych et al.

U.S. Pat. No. 8,571,963 B2 October 2013 Ameriks et al.

U.S. Pat. No. 8,639,604 B1 January 2014 Abrahamson

2006/0122924 A1 June 2006 Brustkern et al.

2006/0149645 A1 July 2006 Wood

2006/0229964 A1 October 2006 Fox

2008/0114703 A1 May 2008 Dahlberg et al.

2009/0281958 A1 November 2009 Abidi et al.

2012/0059770 A1 March 2012 Surz

2014/0229402 A1 August 2014 Caron

### OTHER PUBLICATIONS

John Ameriks et al., Making Retirement Income Last a Lifetime, Journal of Financial Planning, December 2001, p 60-76.

The invention claimed is:

1. A method of automatic target date distribution of retirement funds, the method comprising:
providing a computer processor configured to execute computer readable instructions to automatically distribute retirement funds to investors from a start date to an end date;
providing a regular periodic distribution schedule plan comprising a start date, an end date and frequency of distribution selected by the investor;
calculating purchasing power equalized distribution percentage rate for each distribution from the start date to the end date using expected net investment return rate;
calculating total share numbers of all retirement funds at the distribution time;
determining shares to be sold at the current distribution by multiplying share numbers and distribution percentage rate;
selling shares that are allocated for the current distribution;
making a payment to the investor at the scheduled distribution;
maintaining undistributed funds invested until distribution;

2. The method of claim 1, wherein the regular distribution schedule is executed automatically by a computer program without any intervention from the investor.

3. The method of claim 1, wherein the regular distribution schedule can be modified to different start date, end date and distribution frequency by the investor any time during the distribution time frame.

4. The method of claim 1, wherein the distribution percentage rate is calculated, by a computer program, by factoring in net investment return rate after inflation to create a purchasing power equalized distribution throughout the entire distribution time frame.

5. The method of claim 4, wherein the distribution percentage rate is calculated in a reverse order starting at the last year of distribution, ending at the first year of distribution.

6. The method of claim 4, wherein the distribution percentage rate is calculated in an iterative process using the future year's distribution to calculate the current year distribution.

7. The method of claim 4, wherein the distribution percentage rate calculation starts at 100% at the last year of distribution.

8. The method of claim 4, wherein the distribution percentage rate calculation uses a variable net investment return rate to reflect investment return changes with time due to investments shifting during the distribution time frame.

9. The method of claim 4, wherein the distribution percentage rate is recalculated based on revised expected net investment return rate.

10. The method of claim 1, wherein the distribution percentage rate for the current distribution occurrence is the annual distribution percentage rate divided by the number of distributions per year.

11. The method of claim 1, wherein the distribution percentage rate is calculated with a time unit other than year.

12. The method of claim 1, wherein the distribution percentage rate is obtained from a look up table of FIGS. 5A and 5B of the present invention disclosure.

13. The method of claim 1, wherein the number of shares of a fund to be sold for the current distribution is calculated by multiplying the total number of shares of the fund by the current distribution percentage rate for the current distribution period.

14. The method of claim 1, wherein the retirement funds comprise plurality of investment funds.

15. The method of claim 1, wherein the investor enrolls in multiple distribution plans with different start date, end date, distribution frequency, expected net investment return.

16. The method of claim 1, wherein the retirement funds are fully invested and only the allocated distribution amount are sold for the distribution payment to the investor at each distribution.

17. A method of cash buffering for retirement fund distribution, the method comprising:
shifting the scheduled periodic divesting of retirement funds earlier than the cash payment distribution to the investor by a designated number of periodic distribution occurrences selected by the investor;
divesting/selling the allocated number of shares of funds at each distribution date;
accumulating the proceeds into a cash buffer without payment distribution to the investor for a designated number of periodic distribution occurrences selected by the investor;
distributing cash payment to the investor at each cash payment distribution with the amount of cash buffer value divided by the cash buffer length which is the number of the occurrences of the divesting of the allocated number of share of the funds before cash payments to investor commences;
divesting/selling the allocated number of shares of funds at each distribution date and add the proceeds to the cash buffer;
calculating and notifying the investor the estimated cash distribution value for the next periodic distribution based on the current cash buffer value and cash buffer length
distributing cash payments from cash buffer without adding new cash to the cash buffer for the last number of distributions after all retirement funds have been sold and converted to cash buffer.

18. The method of claim 17, wherein the cash buffer is rolled over to a new retirement fund distribution plan and is assigned a cash buffer length by the investor when the investor changes the distribution plan.

19. The method of claim 17, wherein the cash payment at each distribution equals to the cash buffer values divided by the number of remaining distributions after all funds have been sold and all assets are in the cash buffer.

20. The method of claim 17, wherein the cash buffer is built by selling an additional number of shares at the beginning of the retirement funds distribution plan and assigning a cash buffer length by the investor.
